(19) United States
(12) Patent Application Publication
(10) Pub. No.: US 2019/0247878 A1
(43) Pub. Date: Aug. 15, 2019

(54) DEVICE FOR SEPARATING OVERSPRAY

(71) Applicant: EISENMANN SE, Boblingen (DE)

(72) Inventor: Jürgen Röckle, Magstadt (DE)

(21) Appl. No.: 16/270,828

(22) Filed: Feb. 8, 2019

(30) Foreign Application Priority Data
Feb. 9, 2018 (DE) 10 2018 103 019.3

(51) Int. Cl. B05B 14/43; B01D 46/00; B01D 46/12

(52) U.S. Cl. CPC B05B 14/43; B01D 46/0023; B01D 46/0005; B01D 2279/35; B01D 2267/40; B01D 2267/60; B01D 46/12

(57) ABSTRACT

A device for separating overspray from overspray-laden booth air of surface treatment installations, having at least one separating unit through which overspray-laden booth air can be guided and in which overspray can be separated, wherein the separating unit has a filter device with at least a first and a second filter element and also a first and a second structural element of planar design, wherein the structural elements have through-openings through which the booth air can flow, and wherein the through-openings of the first and of the second structural element are arranged in the flow direction such that the through-openings are not completely aligned with one another in the flow direction.

### RELATED APPLICATIONS

The present application claims priority to German Application No. 10 2018 103 019.3 filed Feb. 9, 2018—the contents of which are fully incorporated herein by reference.

### BACKGROUND OF THE INVENTION

### 1. Field of the Invention

The invention relates to a device for separating overspray from overspray-laden booth air of surface treatment installations, having at least one separating unit through which overspray-laden booth air can be guided and in which overspray can be separated.

### 2. Description of the Prior Art

In the manual or automatic application of paints to objects, a part-flow of the paint that generally contains not only solids and/or binders but also solvents does not reach the object. This part-flow is referred to as overspray. In the following, the terms overspray or overspray particles are to be understood in the sense of a disperse system, such as an emulsion, suspension or a combination thereof. The overspray is captured by the air flow in the painting booth and fed for separation, with the result that the air, where appropriate after a suitable conditioning, can be guided back again into the coating booth.

In installations having a relatively large paint consumption, for example in installations for coating vehicle bodies, use is preferably made in a known manner of wet separating systems on the one hand or electrostatically operating dry separators on the other hand. As an alternative, systems having exchangeable separating units are also used which, after reaching a limit loading with overspray, are exchanged for unladen separating units and disposed of or, where appropriate, recycled. The processing and/or disposal of such separating units can be more energy-compatible and also more compatible in terms of the required resources than in the case of corresponding wet or dry separators.

Such exchangeable dry separating systems can, for example, allow the particle-containing booth exhaust air to flow through labyrinth-like structures and then guide it through a nonwoven which can be provided as a prefilter for a downstream second filter stage. Here, the filter effects of the individual stages are to be tailored to one another.

A disadvantage with this design is that the filter system can be adapted to changing overspray compositions only with difficulty. If, for example, the overspray contains a higher proportion of a certain fraction to be separated than originally planned, the overall filter effect can be adversely affected or result in undesirably short maintenance intervals.

### SUMMARY OF THE INVENTION

It is an object of the invention to specify a device for separating overspray from overspray-laden booth air of the type stated at the outset that can be adapted in a simple manner to changing overspray compositions and that can at the same time be produced and maintained in a cost-effective manner.

The invention may be achieved by a device for separating overspray from overspray-laden booth air of surface treatment installations, having at least one separating unit through which overspray-laden booth air can be guided and in which overspray can be separated, wherein the separating unit has a filter device with at least a first and a second filter element and also a first and a second structural element of planar design, wherein the structural elements have through-openings through which the booth air can flow, and wherein the through-openings of the first and of the second structural element are arranged in the flow direction such that the through-openings are not completely aligned with one another in the flow direction. Further embodiments of the invention are described herein.

The device according to the invention for separating overspray from overspray-laden booth air of surface treatment installations has at least one separating unit. One or more such separating units can be provided for each device. Here, there is generally provision that the entire booth air is divided between the various separating units. Alternatively or in addition, there can be provision that various regions of a surface treatment installation are each assigned one or more separating units.

The overspray-laden booth air can be guided through such a separating unit, and the separating unit is designed to filter out some or all of the overspray from the booth air to such an extent that the outflowing air can be blown off or fed for reuse, for example following an air-conditioning of the booth.

The separating unit according to the invention has a filter device with at least one filter element and a first and a second structural element of planar design. The first and the second structural element each have through-openings. These through-openings are arranged in the structural element such that booth air can flow through. For example, the structural element can cover the entire free flow cross section of the separating unit.

The through-openings of the first and of the second structural element are arranged in the flow direction such that, in the flow direction, through-openings of the first structural element are not completely aligned with corresponding through-openings of the second structural element. Here, the term “not aligned” is to be understood as meaning that booth air which flows through a through-opening of the first structural element cannot flow through a corresponding through-opening of the second structural element without a deflection. Here, the deflection can be realized, for example, by a pure change in direction of the flow, from a change in the area or the shape of the cross section through which flow is to pass or from any desired combination. This can occur, for example, by a different arrangement of the same number of through-openings with the same shape on the different structural elements. Alternatively or in addition, the geometric shape can vary with the area remaining the same and/or the cross-sectional area of the individual through-openings can vary. The number of the through-openings from structural elements to structural element can also be changed.

There can in this way be provided, on the one hand, an inertial filter which can filter out parts of the overspray which is transported with the booth air by a deflection of the flowing booth air. On the other hand, the filter effect of the filter element can be adapted in a simple manner to the respective requirements by changing the cross section through which flow can pass.

In a preferred embodiment, the through-openings of the first and of the second structural element are arranged with respect to one another such that the through-flowing booth air is guided such that an inertial filter effect results. This can occur, as mentioned above, for example by a deflection of the flow between the upstream structural element and the downstream structural element.

In an advantageous development of the invention, there can be provision that the filter element has a first structural element and a second structural element. It is thus possible in this manner to bring about the inertial filter effect already within a filter element. Consequently, the filter element has a corresponding filter effect. A combination of two or more such filter elements allows a precise control of the individual filter effect and of the overall filter effect in a simple manner.

In a particularly preferred development of the invention, there is provision that, as seen in the flow direction, the filter element has a depth filter element between the first structural element and the second structural element. It is possible in this manner for the already explained inertial filter effect to be combined with the depth filter effect of the depth filter element. While the booth air flowing through a through-opening of the first structural element tries to flow through the non-aligned through-opening of the second structural element arranged downstream in the flow direction, the flow is deflected and thus forms the inertial filter effect. At the same time, the booth air flows through the depth filter and is thus subject to a further separating effect. This simultaneous combination of filter effects has been found to be particularly effective in terms of the filter effect and the production costs for such a filter element.

In a likewise preferred development, there is provision in this connection that the depth filter element contains an additive which supports particle agglomeration. Such an additive reinforces the depth filter effect and inertial filter effect in that it facilitates or promotes an attachment of the particles, be they solid particles or droplets, which are situated in the overspray. Such an additive can contain industrial petroleum jelly, for example.

In an advantageous embodiment, there can be provision that the filter element has a frame structure which is connected to the first and/or second structural element. Here, the frame structure can advantageously be designed such that the individual filter element is self-supporting and thus simple handling is possible after production for assembling the separating unit or during a replacement of individual or all filter elements. Here, the frame structure can be formed from the same material as the structural elements or else from a different material. Examples of materials for the structural elements and the frame are wood, cardboard and/or plastic. Here, the frame can be of solid design or formed, for example, by folding one or both structural elements.

In this connection, there can be provision that the frame structure is formed integrally with the first and/or the second structural element.

In a particularly preferred embodiment, there can be provision that, as seen in the flow direction, the filter element has a first structural element, a depth filter element and a second structural element which are connected to one another in a sandwich-like manner. The sandwich design affords, on the one hand, a high intrinsic stability of the filter element that allows simple handling during storage and in particular upon exchange. On the other hand, this design combines two filter types—depth filtering and inertial filtering—in a simple manner in one component. A suitable staggering of the filter effect of a plurality of filter elements behind one another can achieve an overall filter effect which is adapted, for example, to a certain composition of overspray.

In a development of the invention, there is provision that the separating unit has a receptacle for one or more filter elements. Here, a separate receptacle can be provided for each individual filter element. Alternatively, a receptacle can be provided for a plurality of filter elements. A receptacle can be, for example, a slide-in unit in which a filter element is slid from outside or during the production of the separating unit. Alternatively, the filter element can also be able to be inserted into the receptacle or be able to be fastened thereto in some other way.

In one embodiment, a first and a second filter element can be provided.

It is particularly preferred if the first filter element has a different filter characteristic than the second filter element. This allows a “tailoring” of the overall filter characteristic of the separating unit. It is particularly advantageous in this connection if the individual filter elements are able to be introduced separately into the receptacles and can thus be individually exchanged.

One advantageous embodiment provides that the separating unit has at least three filter elements with different filter characteristics. This allows particularly good adaptability of the overall filter characteristic to certain compositions of the booth waste air which is to be purified.

The concept of the invention can also be realized with a coating installation for coating vehicle bodies and with a method for treating overspray of a coating installation respectively having/using a device as described above.

In summary, the invention combines the functions of the inertial separator and of the depth separator in one filter element. Such filter elements, through the possibility of the variation of the interior, make it possible to build up a modular filter design which can be adapted to the corresponding paint. At the same time, such a filter element can be supplemented by an additive in order to adapt the effectiveness of the inertial separation to the paint and at the same time to improve the service lives.

Such filter elements can be arranged multiply behind one another. The filter elements can preferably extend perpendicular to the flow direction over the entire cross section of the separating device. In the flow direction of the exhaust air, it may be expedient, for example, to increase the density of the filling of the individual filter elements in order to increase the filter performance. With a classification of the density of the filter elements from 1=“very permeable” to 10=“very dense”, it may be expedient, in the case of three filter elements arranged behind one another, to employ a scaling of 1-3-8 for example for a paint, whereas for example a scaling of 1-1-5 can achieve better filter results for a different paint system.

In the case of perforated plates mounted in an offset manner, the exhaust air flow can be multiply deflected. Here, the perforated plates act as an inertial separator which traps the particles by deflection of the exhaust air flow.

The filling between the perforated plates has the function of a depth separator. The filling becomes every denser for example along the flow path of the exhaust gas flow within the dry separator in order to be able to trap the ever smaller particles. The sequence of the graduation in the density difference between filter elements can be specifically tailored to the occurring overspray. Thus, it is possible to build up a modular filter design which provides different density combinations on the basis of a matrix for different paints. There can be provision to wet the filling with additives, such as, for example, industrial petroleum jelly. During the use of the painting booth, the additive should not act in a wetting, and thus disturbing, manner on the paint. It can be applied or introduced before or after clamping the filling into the frame. In this respect, it should help in supporting the particle agglomeration while the exhaust air flow is guided through the dry separator. The additive can be configured in such a way that it can be individually adapted to the respectively used paint.

Other advantages and aspects of the present invention will become apparent upon reading the following description of the drawings and detailed description of the invention.

### BRIEF DESCRIPTION OF THE DRAWINGS

Exemplary embodiments of the invention will be explained in more detail below with reference to the drawings, in which:

FIG. 1 shows in a schematic cross-sectional view a painting booth having a separating unit for overspray in which booth air is guided via an air-guiding device to a separating device;

FIG. 2 shows in a perspective partial cutaway view an embodiment of a filter element according to the invention; and

FIGS. 3-5 show in schematic perspective views different embodiments of filter modules.

### DESCRIPTION OF PREFERRED EXEMPLARY EMBODIMENTS

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

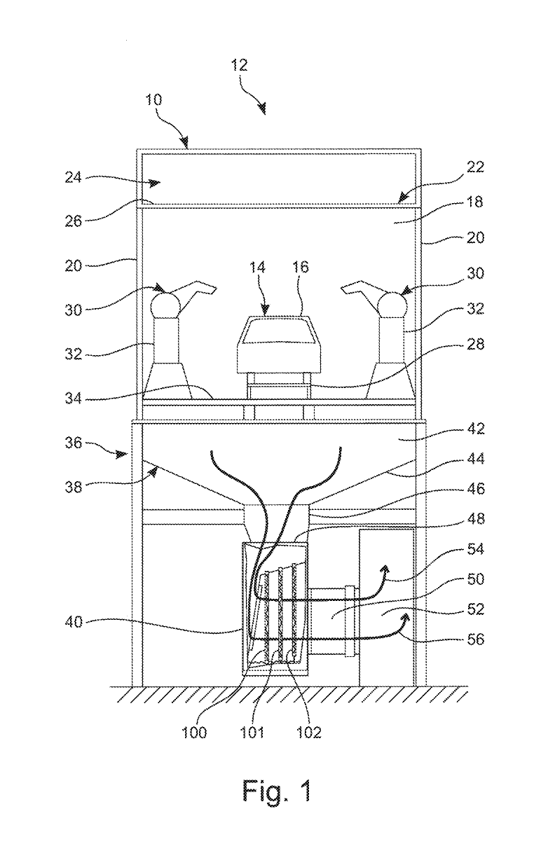

FIG. 1 shows a coating booth 10 and also a surface treatment installation which is designated overall by the reference sign 12 and in which objects 14 are painted. Vehicle bodies 16 are shown as an example of objects 14 to be painted. Before they reach such a coating booth 10, they are for example cleaned and degreased in pretreatment stations (not shown separately). After the coating operation, various post-treatments, such as, for example, drying, take place.

The coating booth 10 comprises, arranged at the top, a coating or painting tunnel 18 which is delimited by vertical side walls 20 and a horizontal booth ceiling 22, but is open at the end sides. Moreover, the painting tunnel 18 is open in such a way that overspray-laden booth air can flow downward. The booth ceiling 22 customarily forms a lower boundary of an air supply chamber 24 and takes the form of a filter ceiling 26. The vehicle bodies 16 are transported from the inlet side of the coating tunnel 18 to its outlet side by a conveying system 28 known per se which is accommodated in the coating tunnel 18. Situated in the interior of the coating tunnel 18 are application devices 30 in the form of multi-axis application robots 32, as are likewise known per se. The vehicle bodies 16 can be coated with the corresponding coating material by means of the application robots 32. This coating operation gives rise to overspray which, as already mentioned, is to be downwardly carried away.

To the bottom, the coating tunnel 18 is open via a walk-on grating 34 toward an installation region 36 arranged therebelow. In this installation region 36, the overspray particles carried along by the booth air are separated from the booth air.

For this purpose, air flows out of the air supply chamber 24 during a coating operation downwardly through the coating tunnel 18 to the installation region 36. Here, the air takes up paint overspray present in the coating tunnel 18 and carries it along with it. This overspray-laden air is guided by means of an air-guiding device 38 to a separating device in the form of one or more filter modules 40.

For this to occur, the air-guiding device 38 comprises, in the exemplary embodiment shown in FIG. 1, a guide duct 42 which is formed by guide plates 44 which extend inwardly and downwardly at an inclination from the side walls 20. The guide duct 42 opens at the bottom into a plurality of connection ducts 46 which for their part terminate at the bottom in a connection nozzle 48.

During a coating operation, each filter module 40 is fluidically and releasably connected to the air-guiding device 38. In the filter module 40, the booth air flows through one or more filter elements at which the paint overspray is separated. This will be discussed in detail below. Overall, each filter module 40 is designed as an exchangeable structural unit and can, where appropriate, also be configured as a disposable filter module.

The booth air which is largely freed of overspray particles after being filtered by the filter module 40 flows out of the filter module 40 into an intermediate duct 50 via which it passes into a collecting flow duct 52. The booth air is fed via the collecting flow duct 52 for further processing and conditioning. Subsequent thereto, the conditioned booth air is guided in a circuit (not shown separately) into the air supply chamber 24 again from which it flows again from above into the coating tunnel 18.

If the booth air is still not sufficiently freed of overspray particles by the filter modules 40 present, yet further filter stages can be arranged downstream of the filter modules 40. These filter stages are fed with the air flowing off from the filter modules 40. Electrostatically operating separators, as are known per se, can also be used there, for example.

As is already indicated in FIG. 1 and will be explained more precisely below, the filter module 40 has a plurality of filter elements 100-102 through which the booth air to be purified can successively flow. The course of the flow in the installation region 36 is symbolically illustrated by the arrows 54, 56.

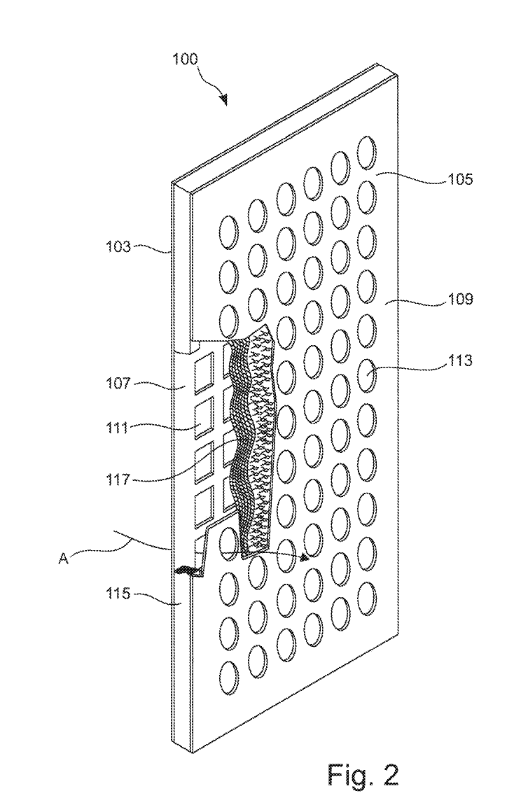

FIG. 2 shows the construction of such a filter element 100 by way of an exemplary embodiment. In the position shown in FIG. 2, flow passes through the filter element 100 from the rear to the front, as illustrated by the arrow A. There correspondingly appears an inflow side 103 and an outflow side 105. The filter element 100 has a first perforated plate 107 on the inflow side and a second perforated plate 109 on the outflow side.

The first perforated plate 107 has substantially square through-openings 111, and the second perforated plate 109 has substantially circular through-openings 113. The two types of through-openings 111, 113 are arranged in a matrix-like manner. In the present embodiment, the number of inflow-side through-openings 111 corresponds to the number of outflow-side through-openings 113 both in terms of number and substantially in terms of arrangement. In alternative embodiments, in order to reinforce the inertial filter effect it would be alternatively or additionally possible to provide both, on the outflow side, a different number of through-openings or a different geometrical shape—preferably a smaller number—and also, alternatively or additionally, to provide a different arrangement of the through-openings.

The inflow-side first perforated plate 107 and the outflow-side second perforated plate 109 are connected to one another via a frame 115. The frame 115 is arranged within the outer peripheral edges of the first and the second perforated plate 107, 109 and thus forms a uniform spacing between the perforated plates 107, 109. The first and the second perforated plate 107, 109 are thus situated substantially parallel to one another. In the embodiment shown in FIG. 2, the interspace situated between the two perforated plates 107, 109 is filled with a filter material 117. The filter material 117 can, for example, take the form of a woven fabric, knitted fabric, filament, random-laid mat, nonwoven, etc.

During a flow through the through-openings 111 of the first inflow-side perforated plate 107, the air flow arising at the perforated plate 107 is divided between the available number of through-openings 111 corresponding to the shape and position. Since the outflow-side perforated plate 109 has differently shaped through-openings 113, the air flow, which spreads out further after the first perforated plate 107, is forced to carry out movements parallel to the plane of the perforated plates 107, 109. An inertial separation takes place during this movement. The resultant filter effect is supported and reinforced by the presence of the filter element 117 which acts as a depth filter. Two filter effects are thus combined at one location. This results in a particularly efficient separation of the overspray situated in the air flow.

In a development of the embodiment shown in FIG. 2, there can be provision that the filter fabric 117 is provided with an additive, such as, for example, industrial petroleum jelly. Such an additive can, on the one hand, adapt the effectiveness of the inertial/depth separation to the currently occurring overspray and at the same time improve the service life of the filter element. The additive results in a higher binding/adhesion of the particles to the filter material 117 of the filter element 100. Particularly in the case of dusty paints, there is frequently to be observed an entrainment effect of the paint particles as a result of abrasion. Here, already deposited particles are detached again by newly impinging particles and entrained. This can be prevented or reduced by the addition of an additive.

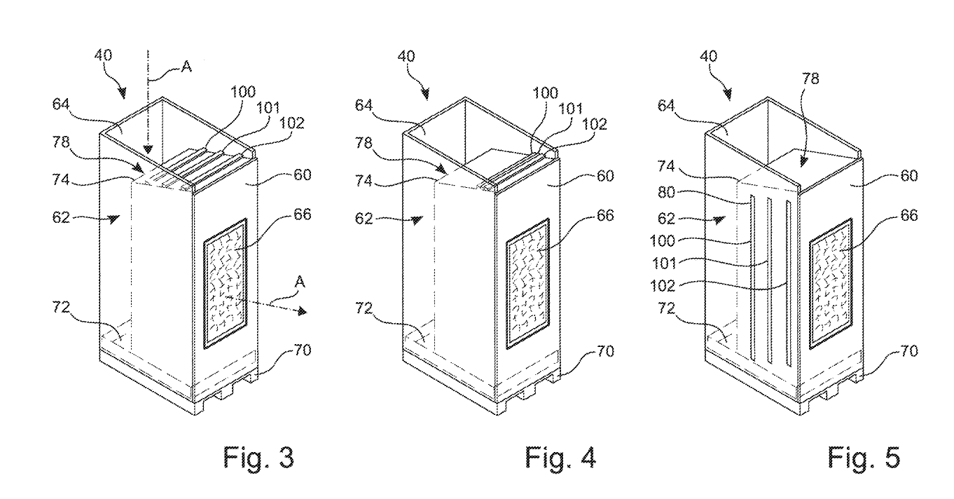

FIGS. 3-5 show different configurations of how filter elements 100-102 can be arranged in and/or removed from a filter module 40.

In the configuration shown in FIG. 3, the filter modules 100-102 are situated approximately at the same spacing from one another within the filter module 40. The filter module 40 has a filter module housing 60 which delimits a filter housing interior 62 which extends between a module inlet 64 and a module outlet 66 and through which the booth air flows. This is illustrated by the arrow A.

The module housing 60 comprises a bottom part 70 which, in the present exemplary embodiment, is designed in its configuration as a standardized supporting structure, for example according to the specification of a euro pallet. Accordingly, the arrangement of a plurality of filter modules in the installation region 36 of the coating booth 10 can occur according to a grid which is based on the standardized bottom part 70 used.

A lower collecting region of the filter module 40 is liquid-tight and in this way designed as a collecting trough 72 for coating material which separates in the filter module 40 and flows off downwardly.

In the filter space 62 there is arranged a holding frame 74 which is designed for holding the filter elements 100-102. The holding frame 74 encompasses a filter space 78 within which the actual filtering of the inflowing and overspray-laden booth air takes place. During the filtering process, the booth air flows along a main flow direction A through the filter space 78 and in so doing strikes the filter elements 100-102. Following the filtering already described above, the thus purified air passes out of the filter module 40 at the module outlet 66 and leaves said module.

In the embodiment shown in FIG. 3, the individual filter elements 100-102 can be introduced into the filter space 78 from above and can be fastened to the holding frame 74, for example by being slid in. For this purpose there can be provided, for example, lateral guide grooves, holding clamps, screw connections, adhesive connections or the like. The filter elements 100-102 are arranged equidistantly and thus have equally wide interspaces in which the air flow can even out again between the individual filtering processes. A separation can thus take place not only within the filter elements 100-102. Rather, given a corresponding configuration of the perforated plates of the individual elements 100-102, a deflection of the outflow can also take place between the individual filter elements, which in turn can lead to an inertial separation. For example, the outflow-side perforated plate 109 of the filter element 100 can have a higher number of through-openings 113 than the inflow-side perforated plate of the filter element 101 situated on the outflow side. Alternatively or in addition, the shape and/or the arrangement of the through-openings can also be different.

An alternative is illustrated in FIG. 4. The filter elements 100-102 there are arranged in direct contact with one another. The advantage of this arrangement lies in the fact that, although no separate inertial separation takes place between the individual filter elements 100-102 and thus the advantage of an additional separation is dispensed with, at the same time the filter effect is thus less dependent on the flow velocities between the individual filter elements 100-102 and is thus more predictable.

FIG. 5 shows an embodiment in which the filter elements 100-102 can be slid in and exchanged via laterally incorporated slots 80 in the filter module 40. This facilitates the maintenance and the exchange of the filter elements 100-102.

In one embodiment, which is not illustrated in the figures, one or more filter elements can also be positioned below the grating 34, at the beginning of the installation region 36—for example horizontally, at the beginning of the guide duct 42 and/or at the beginning of the filter device 40.

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

1. A device for separating overspray from overspray-laden booth air of surface treatment installations, comprising:
a) at least one separating unit through which overspray-laden booth air can be guided and in which overspray can be separated, wherein
b) the at least one separating unit has a filter device with at least one filter element and also a first structural element and a second structural element which are of planar design, wherein
c) the first structural element and the second structural element each have through-openings through which booth air can flow, and wherein
d) the through-openings of the first and of the second structural element are arranged in a flow direction such that the through-flow openings are not completely aligned with one another in the flow direction.

2. The device according to claim 1, wherein the through-openings of the first and of the second structural element are arranged with respect to one another such that through-flowing booth air is guided such that an inertial filter effect occurs.

3. The device according to claim 1, wherein the at least one filter element has a first structural element and a second structural element.

4. The device according to claim 3, wherein, as seen in the flow direction, the at least one filter element has a depth filter element between the first structural element and the second structural element.

5. The device according to claim 4, wherein the depth filter element contains an additive which supports particle agglomeration.

6. The device according to claim 1, wherein the at least one filter element has a frame structure which is connected to the first and/or second structural element.

7. The device according to claim 6, wherein the frame structure is formed integrally with the first and/or the second structural element.

8. The device according to claim 1, wherein the at least one filter element has a depth filter and as seen in the flow direction, the first structural element, the depth filter element and the second structural element of the at least one filter element are connected to one another in a sandwich-like manner.

9. The device according to claim 1, wherein the at least one separating unit has a receptacle for one or more filter elements.

10. The device according to claim 1, wherein a first filter element and a second filter element are provided.

11. The device according to claim 10, wherein the first filter element has a different filter characteristic than the second filter element.

12. The device according to claim 11, wherein the separating unit has at least three filter elements with different filter characteristics.

13. A coating installation for coating vehicle body components having a device according to claim 1.

14. A method for treating overspray of a coating installation comprising the step of using a device according to claim 1.
